(19) United States
(12) Patent Application Publication
(10) Pub. No.: US 2014/0117663 A1
(43) Pub. Date: May 1, 2014

(54) PIPE CONNECTION TO FORM A LIQUID TIGHT SEAL AND METHOD OF FORMING THE SAME

(71) Applicant: MUNRO LTD., Utopia (CA)

(72) Inventors: Benoit Tanguay, Saint-Eustache (CA); John Siervogel, Shelburne (CA); Greg Sebastiano, Stayner (CA)

(73) Assignee: MUNRO LTD., Utopia, Ontario (CA)

(21) Appl. No.: 14/063,838

(22) Filed: Oct. 25, 2013

(30) Foreign Application Priority Data
Oct. 26, 2012 (CA) 2793590

(51) Int. Cl. F16L 13/02

(52) U.S. Cl. CPC F16L 13/0227
USPC 285/288.11; 228/101

(57) ABSTRACT

A pipe connection and pipe and fittings to make a pipe connection that include either a bell plate ring or a complementary spigot ring, which can be readily joined together by welding to form a sealed joint. In particular the bell plate ring includes a tapered, such as a conical section, that has a larger outer diameter (that is closer to the end of the pipe section or fitting) and a smaller diameter in from said end of said pipe section or fitting. In this way the present invention provides an inner bell surface which is generally continuously tapered. In turn a complementary spigot ring is provided with a welding lip having an outer diameter that is between the larger and smaller diameters of the bell plate ring. In this way, when the spigot is inserted into the bell it is first guided by the taper and then an interference fit is made between the welding lip and the bell, which ensure continuous weldable contact between the spigot and the bell. A seal protects the weldable contact from contamination before the weld is made.

### CROSS-REFERENCE TO RELATED APPLICATION

This application claims the benefit of Canadian Patent Application No. 2,793,590, filed Oct. 26, 2012, the entire contents of which are incorporated by reference herein.

### FIELD OF THE INVENTION

This invention relates generally to the field of liquid tight pipelines and more particularly to pipe sections and fittings that may be joined together to form a liquid tight pipeline. Most particularly this invention relates to a liquid tight joint system for such pipes and fittings.

### BACKGROUND OF THE INVENTION

Underground pipes are used for many purposes including for transporting municipal or potable water through a distribution network to households and businesses. Such pipes are also used in power plant cooling water lines, sewage force mains, gravity sewers, subaqueous lines, water intake and discharge lines, industrial pressure lines and the like. Many types of materials can be used for such pipes, such as plastic or steel, but a popular form of such a pipe is a steel reinforced concrete pipe also known as a concrete pressure pipe. In some cases such pipes are also prestressed.

Typically such a concrete pressure pipe is formed from sections which may be made from individual tubular steel sections into which a concrete liner is formed, such as in a mold. A pre-stressing wire may be wrapped around the tubular steel section to provide compression once the concrete lined steel is removed from the mold. An outer layer of concrete may then be applied to the outer surface over the pre-stressing wire and the whole assembly cured. A pipeline formed from such a concrete pressure pipe sections is thought to have tremendous durability as compared to other forms of pipe.

However, to make a continuous pipeline the individual pipe or fitting sections must be joined together. Typically this is done on site in a trench formed in the earth and is accomplished by connecting smaller pipe sections or fittings together to form a continuous pipeline or pipe system. Then dirt is then placed over the completed pipeline to bury the same. However, before the pipeline is covered it is necessary to make sure the sections are sealed together with liquid tight joints.

One way such joints may be formed is by having an overlapping portion where one of the pipe sections fits into the other which is commonly referred to as a “bell and spigot” type of pipe connection. In some cases the joint may also be welded. To form the weld, each section or fitting was provided with either a metal bell ring or a metal spigot ring which fit into the bell ring. The bell ring included a flared outer portion and then a cylindrical portion, and the spigot ring includes an annular ring portion with a smaller diameter than the cylindrical bell portion. The smaller diameter facilitates placing the spigot portion into the bell portion by leaving a gap that allows the insertion to be interference free. The cylindrical spigot section is slid into the cylindrical bell section guided in part by the flared outer portion of the bell portion. Once a sufficient overlap is established between adjacent pipe sections then a weld is attempted between the inner spigot and the outer bell. However, it can be difficult and awkward to form the weld due to various reasons as expressed below.

The first issue is that often there is free water in the trench, which can carry dirt and debris into the gap left between the cylindrical annular lip of the spigot ring and the cylindrical bell. Such dirt and debris can contaminate and thereby damage the integrity of a weld which has to be formed to seal the joint. The second issue arises because traditionally, even when the correct overlap is established, there will remain an exterior facing circumferential groove between the shoulders of the two pipe sections or fittings. Typically this groove is filled with grout on site using a diaper or the like on the outside to keep the grout in the groove. However pushing the grout into the groove can also force grout into the gap between the bell and the annular rim of the spigot ring again contaminating the joint and making forming a water tight continuous weld very difficult if not impossible. As a result there may be a desire to make the weld before the grout is applied. However this is very inefficient as the grout crew then ends up waiting for the weld crew to finish as the two processes are then sequentially related.

The third issue that arises is that the gap between the bell and the spigot which is provided to ease the insertion of the spigot into the bell results in an uneven gap between the components when the sections are in place and ready to be welded. Bridging this uneven gap with weldment is difficult and time consuming and requires a highly skilled welder to be able to complete the weld in a liquid tight fashion. It must be noted that the weld is typically made within an annular channel on the inside surface of a horizontal pipe joint which is difficult and awkward for the welder to reach. Often the welder may be lying down which makes it even more difficult to complete a secure and sealed joint, when the gap is not easily visible to the welder applying the weld.

In addition to the foregoing there is a tendency to form the bell and spigot out of coated metal such as zinc metallized metal. Such materials, while exhibiting good corrosion resistance, are not good candidates for forming a secure weld. Therefore another object of the present invention is to select a material that provides good corrosion resistance and which is readily weldable.

What is desired is a pipe section or fitting that can be used in the formation of a pressure pipeline, for example, that solves these problems in a simple and inexpensive manner. Preferably such a solution would be easy to implement and would reliably improve the quality of the welded joint, while at the same time making the welding easier to complete. Most preferably such a solution would be able to prevent extraneous material from adversely affecting the quality of the weld, unlike the previously existing design discussed above. The possible random presence of weld contaminants and the variable gap make automating welding, such as through the use of a robotic welder difficult if not impossible. Thus a solution that facilitates automatic or robotic welding is also desirable.

Attempts have been made in the past to provide a liquid tight connection between concrete pipes including the following:

U.S. Pat. No. 1,816,770

U.S. Pat. No. 1,941,115

U.S. Pat. No. 2,037,962

U.S. Pat. No. 2,179,629

U.S. Pat. No. 2,808,851

U.S. Pat. No. 3,147,014

U.S. Pat. No. 2,306,531

U.S. Pat. No. 4,084,828

U.S. Pat. No. 7,429,323

Canadian Patent 2,220,207

Great Britain Patent 306,930

Great Britain Patent 318,541

Great Britain Patent 397,440

However, a solution is still being sought.

### SUMMARY OF THE INVENTION

The present invention is directed to pipe and fittings that include either a bell plate ring or a complementary spigot ring, which can be readily joined together by welding to form a sealed joint. In particular the bell plate ring includes a tapered section, such as a conical section that has a larger outer diameter (that is closer to the free end of the pipe section or fitting) and a smaller diameter in from said end of said pipe section or fitting. In this way the present invention provides an inner surface which is generally continuously tapered. In turn the complementary spigot ring is provided with a welding lip having an outer diameter that is between the larger and smaller diameters of the bell plate ring.

In this way, when the spigot is inserted into the bell it is first guided by the taper and then an interference fit is made between the welding lip and the bell, which ensure continuous weldable contact between the spigot and the bell. A second lip is also provided spaced apart from the first lip and which forms a seal retaining channel or groove. A seal is provided which is sized and shaped to seal against an inner surface of the conical bell plate ring, to prevent water, dirt, grout or other material from getting past the seal to the contact area between the welding lip and the bell. Then a weld can be easily made between the inner face of the welding lip and the bell remote from the seal. In this way there is no extraneous material present to interfere with the weld and the lip is in continuous weldable contact with the bell all the way around, thus eliminating the gap of the prior art. The present invention therefore provides a simple and reliably sealed liquid tight joint for a pressure pipe such as a concrete pressure pipe. Further the seal is remote from the weld, on the opposite side of the welding lip from where the weld is made. In this way the seal is somewhat protected from the welding operation and the welder is protected from any fumes or the like that may be produced by the seal degrading under the heat of the weld. A heat resistant or high temperature sealing material is most preferred for the seal.

Therefore, according to a first aspect, the present invention provides a pipe connection to form a seal between two tubulars having confronting ends, one of which may be inserted into the other, said connection comprising a tapered bell plate fixed inside of one of said tubulars, said bell plate having an inside surface defining at least a portion of a cone having a larger diameter towards an end of said tubular and a smaller diameter spaced inwardly from said end, a spigot ring fixed to the other of said tubulars, said spigot ring including an annular welding lip having an outside diameter which is sized to be between said larger diameter and said smaller diameter of said conical bell plate, said annular welding lip being spaced towards an end of said other tubular, and a seal spaced inwardly of said annular tubing lip on said other tubular, said seal being sized and shaped to seal against said conical bell plate when said annular welding lip contacts said conical bell plate, said seal inhibiting foreign matter from passing past said seal, wherein when said other tubular is inserted into said one of said tubulars an interference fit is achieved, causing substantially continuous annular weldable contact between said annular welding lip and said conical portion of said bell ring to facilitate forming a weld along said substantially continuous annular contact.

According to a second aspect, the present invention provides a tubular for joining to another tubular in a liquid tight joint, the tubular comprising: a bell plate fixed to one end of the tubular, the bell plate having an inside surface which defines at least a part conical section having a larger diameter towards an end of said tubular and a smaller diameter in from said end towards a middle of said tubular, a spigot ring fixed to an opposite end of said tubular said spigot ring including an annular welding lip having an outer diameter which is sized to be between said larger diameter and said smaller diameter of said conical bell plate, said spigot ring further including a seal spaced inwardly of said annular welding lip, said seal being sized and shaped to seal against said conical bell plate when said annular welding lip is in substantially continuous annular contact with said conical bell plate.

According to a third aspect, the present invention provides a method of field forming a liquid tight seal between two tubulars, the method comprising:
a. Inserting a male spigot end into a tapered female bell end;
b. Simultaneously forming an interference fit between a welding lip on said male spigot end and said tapered bell plate, sealing said welding lip against the ingress of welding contaminants and creating an inner annular gap between said tubulars to provide access for welding equipment to said welding lip; and
c. Welding said welding lip to said tapered bell to create a liquid tight joint.

### BRIEF DESCRIPTION OF THE DRAWINGS

Reference will now be made, by way of example only, to preferred embodiments of the invention by reference to the following figures, in which:

FIG. 1 shows two tubulars in the process of being joined together according to the present invention;

FIG. 2 shows the tubulars of FIG. 1 joined together;

FIG. 3 shows the cross-section through plane A-A of FIG. 1; and

FIG. 4 shows an enlarged view of the circle 4 of FIG. 3.

### DETAILED DESCRIPTION OF THE PREFERRED EMBODIMENTS

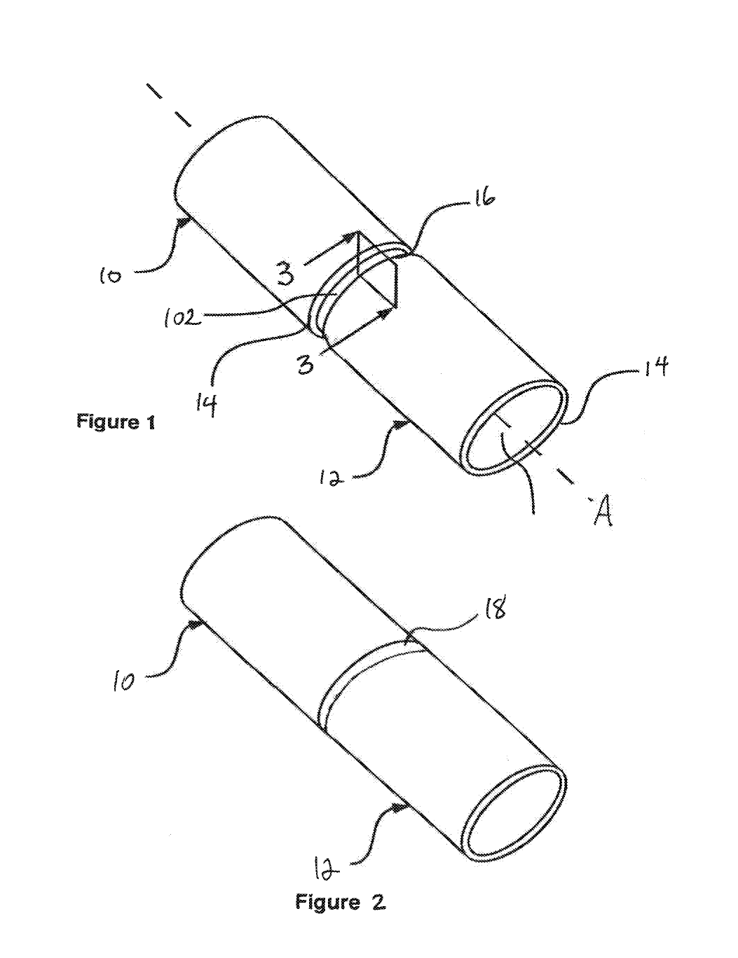

In this specification the term “tubular” is used and will be understood by those skilled in the art as a general term which comprehends pipe sections, fittings and the like that may connected together to help define a tubular bore which defines or makes up a pipeline or pipeline network through which liquids and the like may be transported. FIG. 1 shows two exemplary tubulars being connected together, namely pipe sections 10 and 12. However, it will be understood by those skilled in the art that these are shown by way of example only and that either pipe section could be replaced with an elbow, manifold, or other fitting without departing from the scope of the present invention. Many forms of tubular are comprehended by the present invention including fittings such as elbows, manifolds and the like. All that is required is that the tubular be joined to the pipeline to extend the bore of the pipeline to permit the material being carried by the pipeline to be directed to a desired location.

The pipe section 10 includes an end portion 14 which confronts an end section 16 of the pipe section 12. As shown, the end portion 14 is generally in the form of a female end portion and the end section 16 is generally in the form of a male end portion and there is an overlap established between the ends 14 and 16, when the male end 16 is fit into the female end 14 in a manner described in more detail below. Thus, while the drawings show the tubular in the form of pipe sections the present invention is not limited thereto. Also shown is a longitudinal axis A. As will be understood by those skilled in the art the various tubulars formed into a pipeline will be generally co-axial with the longitudinal axis A.

The most preferred form of the pipe section is a concrete pressure pipe of the type previously described. Such a pipe section includes a concrete liner layer, which is cast within a metal tube or can. Most preferably a pre-stressing wire wrap is provided on the outside of the can. A further layer of concrete may be applied to the outside of the pre-stressing wire wrap to protect the same. Although using this type of pipe construction has been found to yield good results, the present invention is not limited to any particular pipe design. Other styles of pipe are also comprehended by the present invention, and the present invention is applicable to any design of pipeline tubular providing only that the pipeline tubular requires a welded liquid tight joint to be made, to join the tubular to the next element in the pipeline assembly and such joint is to be made in the field.

FIG. 2 shows the tubular 10 joined to the tubular 12 to form a section of pipeline. A grout ring 18 is shown filling in an annular groove as explained in more detail below.

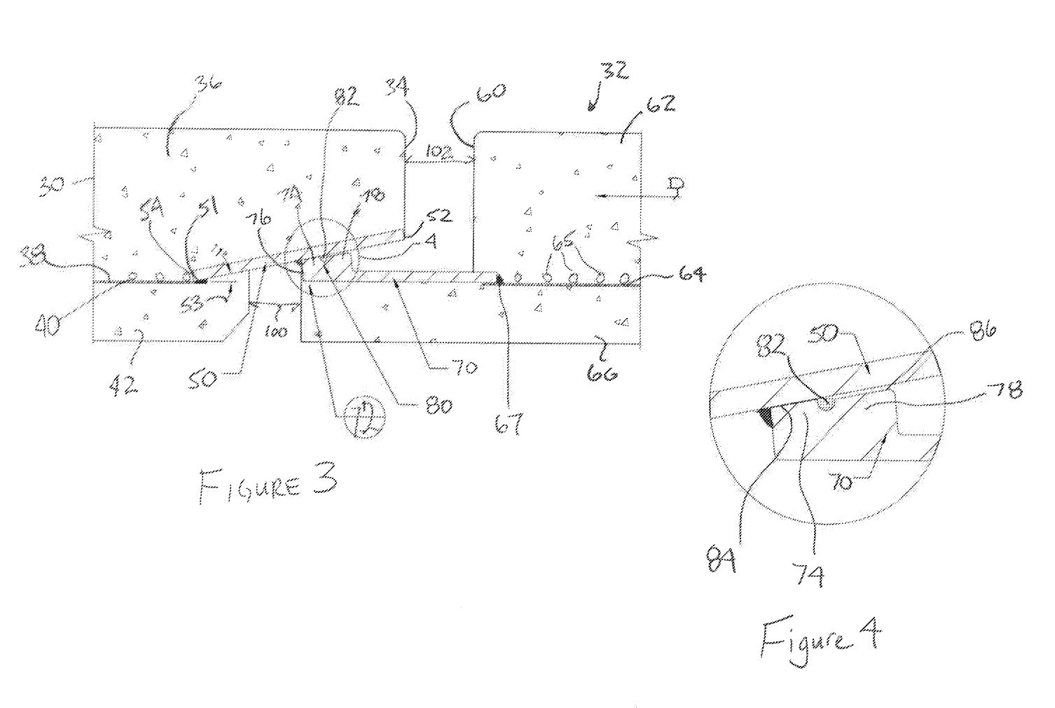

FIG. 3 shows a female tubular 30 and a male tubular 32 being joined and is the close up 3-3 of FIG. 1. In this Figure the male tubular 32 has been inserted into the female tubular 30 in the direction of arrow D. The female tubular 30 includes an abutting or confronting face 34, an outer layer of concrete 36, a metal tube 38, preferably reinforcing pre-stressing wire 40 and an inner concrete layer 42. A bell plate or ring 50 is provided that is fixed to the female tubular 30. In the most preferred form the bell plate is welded or otherwise secured to the metal tube 38 at 51. Most preferably the bell plate or ring 50 is welded to the metal tube 38 before the inner layer of concrete 42 is molded onto the tubular 30, to ensure that a good reliable weld is formed about the entire circumference of the contact joint between the bell plate 50 and the metal tube 38.

Most preferably the bell plate 50 is made from steel or another suitable weldable metal. In the most preferred embodiment the plate can be made about 9.5 mm thick but other thicknesses can be used depending upon the size of the pipe being formed. Further, according to the present invention the bell plate 50 is most preferably coated with an optional corrosion resistant protective coating, but one that is a weldable primer type of coating. A zinc coating such as is used in the prior art or any other coating or treatment that interferes with the welding step is to be avoided according to the present invention.

According to the present invention, the bell plate 50 is in the form of a part of a cone with a larger diameter at an end 52 and a smaller diameter spaced inwardly therefrom at the other end 54. The angle 53 of the cone can vary between about 5 and 20 degrees with about 11 degrees being the most preferred. What is required is to form a female opening which get progressively smaller the further in from the face 34 one gets. Although the present invention is described in respect of a circular pipe it will be understood by those skilled in the art that other shapes of pipe may also be used, such as square or the like. What is most preferred however is to allow the reduction in the area of the female opening to be made fairly gradually going inwardly, to facilitate smoothly sliding the male end into the female opening. The length of the conical section is preferred to be between 115 mm and 160 mm, along the longitudinal axis A, with 125 mm providing reasonable results.

Turning now to the male tubular 32, it may also be provided with an abutting or confronting face 60 formed on an outer layer of concrete 62. Again a metal tube 64 is shown which preferably may be wrapped by pre-stressing wire 65 in a known manner. An inner layer of concrete 66 is also shown. In this tubular 32 a spigot ring 70 is also shown. Similar to the bell plate or ring 50, the spigot ring 70 is preferably welded at 67 to the metal tube 64 to form a sealed joint all around the circumference. Again it is preferred to weld the spigot ring 70 to the tube 64 before the outer layer of concrete 62 is applied. The spigot 70 may be made from the same metal as the bell plate and provided with the same optional corrosion resistant but weldable coating.

Unlike the bell plate though, the spigot plate is in the form of an annular tube having a generally constant diameter along its length until one reaches the internal edge or end 72. The actual form of the spigot plate can vary though as the dimensionally sensitive portion is at the free end (before welding) of the spigot plate. More specifically, at the end 72 there is provided a weld lip 74 which has an outer edge 76. Most preferably a second lip 78 is also provided which defines a seal retaining groove 80. A seal 82 is retained in the seal retaining groove. Most preferably the seal is formed of a compressible elastomer which is a heat resistant elastomer as described in detail below. The seal 82 is sized and shaped to seal against the bell plate 50 when the male tubular 32 is inserted into the female tubular 30 as described. In other words, the seal 82 extends above a top surface of the welding lips, so it may be compressed when the male member is fully inserted in the female member.

As shown in FIG. 4 the welding lip 74 and the second lip 78 are formed with angled top faces 84 and 86. Most preferably the angled top faces 84 and 86 are compatible with the taper angle, for example of the part cone of the bell plate 50. In this sense compatible means that they may be generally at the same as the angle of the bell plate 50. Most preferably the angle of the cone of the bell is about 11 degrees, and the angle of the top surface 74 is sufficiently the same to insure a tight fit namely weldable contact about the periphery of the circumferential contact between plate 50 and top face 84 of welding lip 74. As can be seen in FIG. 4, the welding lip 74 preferably contacts the bell plate, but the second lip 78 does not. This permits an interference fit to be made on the forward or welding lip 74 only. While the second lip 78 could also make contact, this would make insertion of the male member into the female member more likely to bend prematurely and this is less desirable. Further, the top surface 84 has a span or distance S which is sufficient to form a good plugging fit. The distance S is preferably long enough to allow for some wicking of weldment along the top surface 84 into any narrow gaps that might exist, which also facilitates forming a good liquid tight seal between adjacent tubulars.

Most preferably the welding lip 74 extends up at an angle to the balance of the spigot plate. The most preferred angle is about 90 degrees, although the present invention also comprehends the lip being angled forward or rearwardly slightly. A forward angle (towards the female member) is slightly preferred, for ease of welding. Being angled slightly out and into the gap (shown as 100) makes the weldable contact line easier to reach for welding a weld at 75. As well the present invention further comprehends optionally forming the lip 74 from a material that can deform slightly to conform to the contact surface defined by the tapered bell plate. While it is understood that a male tubular which is exactly co-axial with the female tubular will form a perfect circle of weldable contact within the taper, in the field such precision of alignment is difficult to obtain. There will be cases where the tubulars will not be perfectly aligned, due to this being a field made connection and possibly being made by heavy constructions equipment in difficult conditions. Even a slightly askew alignment can cause gaps in the weldable contact due to the misalignment. Thus, the provision of a slightly forward thrusting welding lip and/or a welding lip which is deformable, allows weldable contact to be established generally about the perimeter, even for slightly misaligned tubulars. According to the present invention, the welding lip is sized, shaped and/or positioned to slightly deform when making contact with the tapered bell plate to provide generally continuous weldable contact even about a slightly oval contact perimeter caused by, for example, a small misalignment of tubulars. This slightly deformability arises in part because of the large forces applied by mechanical equipment used to mate the tubulars together.

In other words, directly contrary to the gap fit of the prior art, which was chosen to facilitate ease of field insertion of the two tubulars, the present invention provides a tapered interference fit, where one or more of the contacting components are optionally configured to be slightly deformable which has been chosen to ensure tight generally continuous weldable contact of even slightly misaligned tubulars to facilitate an improved quality of sealing weld.

The operation of the present invention can now be understood. As the male spigot ring 70 is inserted into the female bell plate 50 in the direction D it will be gently guided and centered by the tapered female opening of the bell plate 50 until there is interference, namely, until the welding lip 74 is in continuous weldable contact about its periphery with the bell plate 50. Depending upon the amount of force used to push the two components together there will be varying amount of inference and possible deformation in the fit. However it is intended that the two components are pushed together enough so as to create at least some interference so that continuous, in this case, annular, contact between the welding lip and the bell plate is achieved. On a small enough scale there will be small gaps in any such contact, depending upon the manufacturing tolerances of the components and the like, but the term generally continuous contact is intended to comprehend contact which is sufficiently extensive to permit a robotic weld to be performed around the contact line, without the need for different weldment sizes or a human operator to weld a variable sized gap closed as is required by the prior art.

Turning back to FIG. 3, it will be noted that the outer diameter of the welding lip is smaller than the largest diameter of the bell plate at end 52, but larger than the smallest diameter of the bell plate at end 54. In this way there will at some point always be an inference fit between the bell plate and the welding lip as the male tubular is inserted within the female tubular. According to the present invention the diameter of the welding lip is chosen, relative to the taper and position of the bell plate 50 so as to leave an inner annular gap 100 and an outer annular gap 102 between the confronting ends of the tubular 30, 32. The inner annular gap 100 is required to allow a welding instrument to be placed up against the weldable contact line between the welding lip 74 and the bell plate 50. The outer annular gap is required to allow a layer of grout to be added to cover and protect the otherwise exposed metal of the bell plate 50 and the spigot ring 70. While various dimensions can be chosen good results have been achieved when the inner annular gap 100 is about 50 mm and the outer annular gap 102 is about 60 mm.

Some of the features and advantages of the present invention can now be appreciated. As the spigot ring 32 is forced into the bell plate 30 a tight contact is established by the welding lip 74 against the sloped bell plate 50. Thus a weld can easily be made along the contact line with a minimum of weldment as there will be few if any gaps. As well, the seal is in place once the one tubular is inserted within the other. Thus grout may be applied or mud or the like can be washed into the outer annular channel 102 without coming into contact with the welding lip 74 or threatening the quality of a weld which is to be made to seal the joint. In this way the welding lip 74 contact with the bell plate 50 is kept clean and secure and the welding step can now be divorced in time from the grouting step. In other words, the outer annular groove 102 can be filled with grout according to a grout delivery schedule and the welding of the internal joints can be accomplished according to a welding schedule each of which is independent of one another, leading to less waiting time and a more efficient overall pipeline construction and installation.

It will also be noted that the seal 82 is remote from the weld, being separated from the welding edge of the welding lip by the distance S from where the weld is made. This distance S is sized to reduce or minimize the degradation of the seal during the welding process. Although some heating of the rear weld area is inevitable, by providing a distance S that is large enough, the seal can be somewhat protected from overheating. As noted above the seal is preferable made from a heat resistant material in any event to further avoid seal degradation. It will also be understood that the tight fitting interference contact between the metal elements facilitates the use of an automatic or robotic welding apparatus, that can easily track and weld along the intersection or continuous annual contact weld line. The present invention further requires only a small o-ring type of seal as shown, as due to the improved weldable contact, a sealed weld is made, so, unlike the prior art where the seal was required to keep fluid from within the pipe from leaking out, in this case the weld keeps the pipe sealed. The o-ring seal 82 is a temporary seal only intended to prevent water and water born weld contaminants like grout from leaking into the contact area between the bell and the spigot plates before welding.

It will be understood by those skilled in the art that various changes can be made to the invention without departing from the broad scope of the invention which is defined by the appended claims. While some of these variations have been discussed above, other will be apparent to those skilled in the art. For example, while various forms of metal can be used, a weldable corrosion resistant metal is most preferred.

We claim:

1. A pipe connection to form a liquid tight seal between two tubulars having confronting ends, one of which may be inserted into the other, said pipe connection comprising tapered a bell plate fixed inside of one of said tubulars, said bell plate having an inside surface defining opening having a larger area towards an end of said tubular and a smaller area spaced inwardly from said end, a spigot ring fixed to the other of said tubulars, said spigot ring including an annular welding lip defining an area which is sized to be between said larger area and said smaller area of said tapered bell plate, said annular welding lip being spaced towards an end of said other tubular, and a seal spaced inwardly of said annular tubing lip on said other tubular, said seal being sized and shaped to seal against said tapered bell plate when said annular welding lip contacts said tapered bell plate, said seal inhibiting foreign matter from passing past said seal, wherein when said other tubular is inserted into said one of said tubulars an interference fit is achieved causing substantially continuous annular weldable contact between said annular welding lip and said tapered portion of said bell ring to facilitate forming a weld along said substantially continuous annular weldable contact.

2. The pipe connection of claim 1 wherein the bell plate is in the form of a part cone and said welding lip defines a circular area which fits into said cone.

3. The pipe connection of claim 1 wherein the spigot ring further includes a second lip spaced inwardly from the first lip to define a seal retaining groove, and said seal is carried in said seal retaining groove.

4. The pipe connection of claim 1 wherein annular welding lip is provided with an outer surface, and said outer surface is at an angle relative to an longitudinal axis of said tubular.

5. The pipe connection of claim 4 wherein said angle of said outer surface is no more than about seven degrees different from an angle of said bell plate.

6. The pipe connection of claim 1 wherein said welding lip is sized to create an interference fit before said confronting faces meet, wherein an outer annular groove is formed between said tubulars.

7. The pipe connection of claim 6 wherein said outer annular groove is filled with grout.

8. The pipe connection of claim 1 wherein said welding lip is sized to create an interference fit before said confronting faces meet, wherein an inner annular groove is formed between said tubular.

9. The pipe connection of claim 8 wherein said inner annular groove is sized and shaped to permit a welding instrument to be used in said inner annual groove.

10. A tubular for joining to another tubular in a liquid tight joint, the tubular comprising:
a bell plate fixed to one end of the tubular, the bell plate having an inside surface which defines at least a part conical section having a larger diameter towards an end of said tubular and a smaller diameter in from said end, a spigot ring fixed to an opposite end of said tubular said spigot ring including an annular welding lip having an outer diameter which is sized to be between said larger diameter and said smaller diameter of said conical bell plate, said spigot ring further including a seal spaced inwardly of said annular welding lip, said seal being sized and shaped to seal against said conical bell plate when said annular welding lip is in substantially continuous annular contact with said conical bell plate.

11. A method of field forming a liquid tight seal between two tubulars, the method comprising:
a. Inserting a male spigot end into a tapered female bell end;
b. Simultaneously forming an interference fit between a welding lip on said male spigot end and said tapered bell plate, sealing said welding lip against the ingress of welding contaminants and creating an inner annular gap between said tubulars to provide access for welding equipment to said welding lip; and
c. Welding said welding lip to said tapered bell to create a liquid tight joint.

12. The method of claim 11 further including the step of forming an outer annular groove, and filling said outer annular groove with grout, either before or after said welding step has occurred.
